(19) United States
(12) Patent Application Publication
(10) Pub. No.: US 2019/0244177 A1
(43) Pub. Date: Aug. 8, 2019

(54) SOCIAL AND BUSINESS EVENT ARRANGEMENT

(71) Applicant: International Business Machines Corporation, Armonk, NY (US)

(72) Inventors: Paul R. Bastide, Boxford, MA (US); Matthew E. Broomhall, Goffstown, NH (US); Robert Loredo, North Miami Beach, FL (US); Fang Lu, Billerica, MA (US)

(21) Appl. No.: 15/887,716

(22) Filed: Feb. 2, 2018

(51) Int. Cl. G06Q 10/10; G06F 17/30

(52) U.S. Cl. CPC G06Q 10/1095; G06Q 10/0633; G06F 17/30867

(57) ABSTRACT

A method, system and computer program product for automatically arranging an event's agenda. Profiles are collected for attendees of the event, wherein the profiles include the attendees' social relationships, working relationships and job functions. The attendees' social relationships are analyzed to generate a social relationship graph that includes weightings for the attendees based on how well known they are to others of the attendees. The attendees' working relationships are analyzed to generate an organizational chart that includes the attendees' positions. The attendees' job functions are analyzed to generate rankings for the attendees based on task dependencies. An order for topics on the agenda is suggested according to the rankings for the attendees; introductions are suggested for the agenda according to the weightings for the attendees in the social relationship graph; and keynote speeches are suggested for the agenda according to the attendees' positions in the organizational chart.

### BACKGROUND

The present invention relates generally to a system for meeting facilitation. There are a number of issues related to meeting facilitation.

Meetings and conference calls are tools that speed innovation, improve productivity and connect people more quickly to resolve problems and issues. However, many reports still highlight the dissatisfaction users have with meetings. Specifically, many users feel they are wasting time in meetings. These reports are strong indicators of the dissatisfaction with the amount of time wasted in meetings.

For example, people need to work with other people they may not be familiar with. Sometimes, people may feel ill at ease making introductions during the meeting. As a result, the meeting may not be very productive due to these types of circumstances. Thus, there is a need to intelligently arrange a meeting's agenda, so that attendees can easily transition from introductions into discussions about specific topics, even though they need to talk to people they have never met.

In addition, when creating an agenda for social and business events, an organizer may struggle with what is the correct order of topics to be discussed. Different factors come into play when the organizer needs to decide on the ordering of topics. The factors can include, but are not limited to, the following:
1. Social relationships: for example, how familiar people are with each other could play a very important role when deciding what topics to be discussed. It is important to allow the transition between topics to happen smoothly. This is also true for any introductions when the attendees do not know each other.
2. Organizational charts: for example, sometimes organizational seniority is very important when arranging a meeting agenda. Specifically, it is important in terms of respecting the more senior management among the meeting's attendees.

Overall, there is a need to intelligently arrange social and business events, and the agenda therefor, in a way so that people can easily transition from introductions into a discussion of agenda topics, even though they need to talk to people they have never met.

There exist some technologies relating to meeting facilitation. However, none of these technologies have any functions that explicitly attempt avoidance of irrelevant discussions.

### SUMMARY

The invention provided herein has a number of embodiments useful, for example, in implementing a computer-implemented system and method for automatically arranging an event's agenda by: collecting profiles for attendees of the event, wherein the profiles include the attendees' job functions; analyzing the attendees' job functions, as well as transitions and workflows in the attendee's job functions, to generate rankings for the attendees based on task dependencies; and suggesting an order for topics on the agenda according to the rankings for the attendees.

The attendees whose job functions are at a beginning of the task dependencies have higher rankings than the attendees whose job functions are at a later stage or an end of the task dependencies. The suggested order for topics on the agenda has the attendees with the higher rankings present before the attendees with lower rankings.

The profiles may also include the attendees' social relationships, wherein the system and method further comprise: analyzing the attendees' social relationships to generate a social relationship graph that includes weightings for the attendees based on how well known they are to others of the attendees; and suggesting introductions for the agenda according to the weightings for the attendees in the social relationship graph. The attendees who are more commonly known have greater weightings in the social relationship graph than the attendees who are less commonly known. The suggested introductions are made by the attendees with the greater weightings in the social relationship graph.

The profiles may also include the attendees' working relationships, wherein the system and method further comprise: analyzing the attendees' working relationships to generate an organizational chart that includes the attendees' positions; and suggesting keynote speeches for the agenda according to the attendees' positions in the organizational chart. The suggested keynote speeches are made by the attendees positioned higher in the organizational chart.

The automatically arranging step or function is performed when a meeting invitation is being drafted. Moreover, predefined rules may be applied to the agenda, wherein the rules concur or override the agenda. Further, the social and business culture based on a location of the event, as well as a cultural background of the attendees, may be considered when arranging the agenda. Finally, the agenda may be re-arranged or re-calculated as attendees are added to or removed from the event.

### BRIEF DESCRIPTION OF THE DRAWINGS

Referring now to the drawings in which like reference numbers represent corresponding parts throughout:

FIG. 1 is a pictorial representation of a system for social and business event arrangement is presented in which the invention may be implemented.

FIG. 2 is a block diagram illustrating how the system and method for social and business event arrangement is implemented, according to one embodiment.

FIG. 3 is a pictorial representation of a social relationship graph for event attendees, according to one embodiment.

FIG. 4 is a pictorial representation of an organizational chart for event attendees, according to one embodiment.

FIG. 5 is a pictorial representation of a user interface for a function defining a meeting invitation, according to one embodiment.

FIG. 6 is a flowchart illustrating the steps performed by the system when implementing the computer-implemented method of this invention, according to one embodiment.

### DETAILED DESCRIPTION

In the following description, reference is made to the accompanying drawings which form a part hereof, and in which is shown by way of illustration one or more specific embodiments in which the invention may be practiced. It is to be understood that other embodiments may be utilized and structural and functional changes may be made without departing from the scope of the present invention.

Overview

The present invention is a computer-implemented system for meeting facilitation that intelligently arranges an agenda for social and business events or meetings, including topics to be discussed, based on the following factors:
social relationships among an event's attendees,
working relationships among the attendees,
job functions of the attendees, and
respect for the local social or business culture.

The present invention uses these factors to perform the following computer-implemented steps or functions:
A step or function that collects the event attendees' profiles, including the attendees' social relationships, working relationships and job functions.
A step or function that analyzes the attendees' social relationships to generate a social relationship graph weighting the attendees according to how well known they are to other attendees.
A step or function that analyzes the attendees' working relationships to generate an organizational chart of the attendees according to their position.
A step or function that analyzes the attendees' job functions, as well as the transitions and workflows in the attendee's job functions, and provides rankings for the attendees based on task dependencies.
A step or function that considers the social and business culture based on a location of the event, as well as the cultural background of the attendees.
A step or function that suggests an agenda for the event, including an order for topics on the agenda, as well as introductions and keynote speeches, based on the attendees' weightings in the social relationship graph, the attendees' positions in the organizational chart, and the attendees' rankings based on task dependencies.

The advantages of the present invention include improving attendee and/or event productivity and efficiency.

Hardware and Software Environment

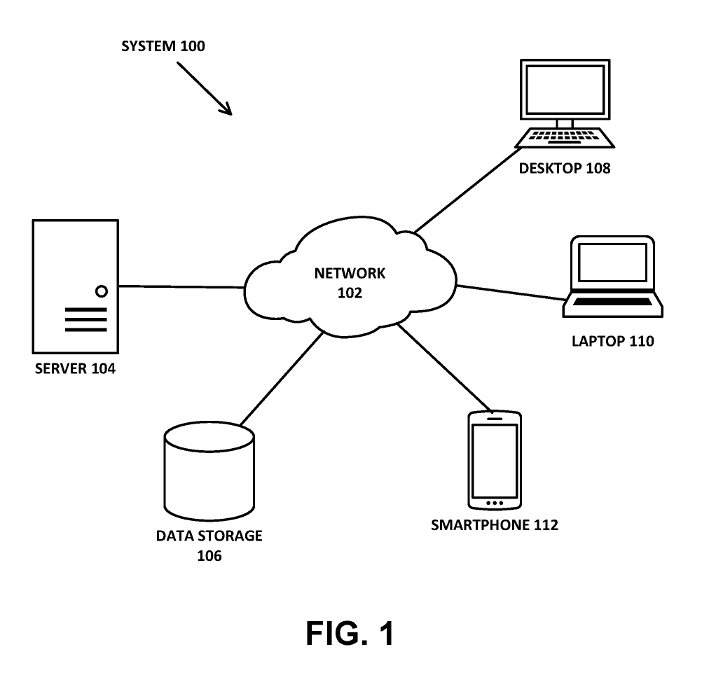

With reference now to FIG. 1, a pictorial representation of a system 100 for social and business event arrangement is presented in which the invention may be implemented. The system 100 not only facilitates meetings, it helps in avoiding irrelevant discussions during the meetings.

The system 100 includes a network 102, which is the medium used to provide communications links between various devices and computers connected together within the system 100. In the depicted example, the network 102 may be a local area network (LAN), wide area network (WAN), the Internet, or another network.

In the depicted example, a server computer 104 is connected to the network 102 along with a data storage unit 106. In addition, client devices 108, 110, 112 are connected to the server computer 104 via the network 102. These client devices 108, 110, 112 may be, for example, desktop computers 108, laptop or notebook computers 110, smartphones 112 and other devices.

In the depicted example, the server computer 104 provides data and programs to client devices 108, 110, 112. Specifically, the server computer 104 implements the functionality of the system 100 for social and business event arrangement and for providing a suitable graphical user interface accessible by users of the participating client devices 108, 110, 112. These aspects of the system 100 are described in more detail below.

System Components

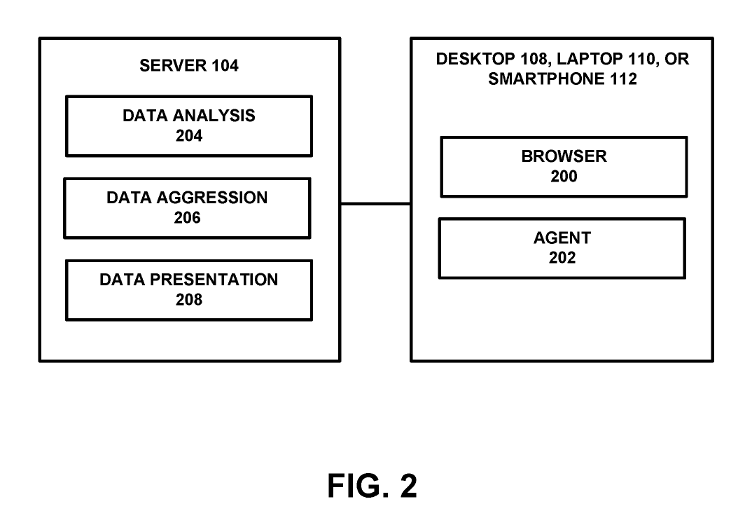

FIG. 2 is a block diagram illustrating how the system and method for social and business event arrangement is implemented, according to one embodiment. In this embodiment, the system and method for social and business event arrangement is implemented by:
a browser 200 and/or an agent 202 executed on a user's devices 108, 110, 112, wherein the browser 200 and the agent 202 are used to organize and schedule events, as well as update profiles of the attendees; and
a plurality of modules 204-208 executed on the server 104 that communicate with the browser 200 and agent 202 installed on the user's devices 108, 110, 112 to schedule events, arrange an agenda for the event, and assign roles to attendees of the event.

In alternative embodiments, however, some of these functions may be performed on different ones of the server 104 or client devices 108, 110, 112, or may be wholly performed on the server 104 or client devices 108, 110, 112.

To organize and schedule events, the server 104 implements the following modules and functionality.

A Data Analysis module 204 collects profiles for attendees of the event, including the attendees' social relationships, working relationships and job functions.

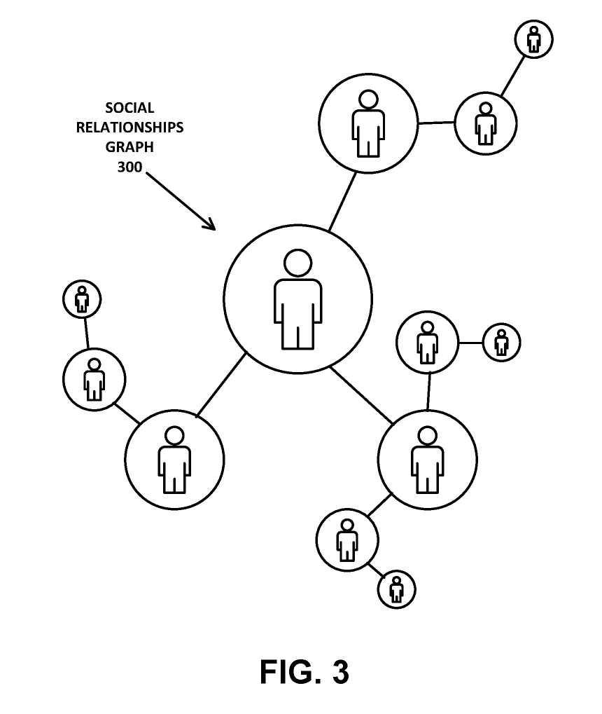

The Data Analysis module 204 analyzes the attendees' social relationships to generate a social relationship graph for the attendees, shown as 300 in FIG. 3. The attendees are assigned different weights in the social relationship graph 300 according to how well known they are to others of the attendees. In this example, the different weights used for the attendees in the social relationship graph 300 are represented by the size of an icon representing each attendee. Attendees who are more commonly known have higher weightings, and are represented by larger icons, in the social relationship graph 300 than attendees who are less commonly known and have lower weightings, and are represented by smaller icons, in the social relationship graph 300.

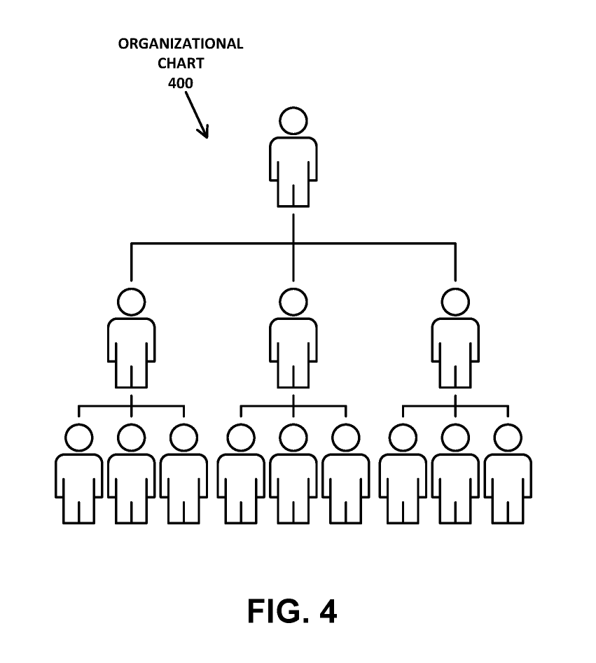

If the attendees work at the same company, then the Data Analysis module 204 also analyzes the attendees' working relationships to generate an organizational chart that includes the attendees, shown as 400 in FIG. 4. The organizational chart 400 shows the attendees' positions in the company.

In addition, the Data Analysis module 204 analyzes the attendees' job functions, as well as transitions and workflows in the attendee's job functions, to generate rankings for the attendees based on task dependencies. The attendees whose job functions are at a beginning of the task dependencies have higher rankings than the attendees whose job functions are at a later stage or an end of the task dependencies. For example, a design team may have higher rankings than a development team, which may have higher rankings than a testing team, in accordance with their respective task dependencies.

The Data Analysis module 204 further considers the local social and business culture based on the location of the event, as well as the cultural background of the attendees.

A Data Aggression module 206 accepts this information from the Data Analysis module 204, and automatically arranges the event's agenda based on this information.

In one aspect, the Data Aggression module 206 suggests an order for topics on the agenda according to the rankings for the attendees, based on the attendees' job functions and task dependencies, such that the attendees with higher rankings present before the attendees with lower rankings. For example, a design team having higher rankings may present before a development team having lower rankings, and the development team may present before a testing team having the lowest rankings, in accordance with their respective task dependencies.

In another aspect, the Data Aggression module 206 may suggest introductions for the agenda according to the weightings for the attendees in the social relationship graph 300. For example, the suggested introductions may be made by the attendees with the higher weightings in the social relationship graph 300.

In another aspect, the Data Aggression module 206 may suggest keynote speeches for the agenda according to the attendees' positions in the organizational chart 400. For example, the suggested keynote speeches may be made by the attendees positioned higher in the organizational chart 400, wherein the suggested keynote speeches may comprise opening or closing statements.

The Data Aggression module 206 can also arrange the agenda based on the conventions of the local culture or the cultural aspects of the attendees. For example, in some cultures, certain attendees may have certain important roles, so they could be arranged to present topics before other attendees.

A Data Presentation module 208 may apply predefined rules to the agenda, wherein the rules concur with or override the agenda. These predefined rules can be configured or updated based on the goals of the event. For example, if the event is a formal business meeting, then the rules may concur with the suggestion of having the more commonly known attendee in the social relationship graph 300 make the introductions. In another example, if the event is an informal business meeting, then the rules may override the initial suggestion and instead suggest that the attendees introduce themselves.

Finally, these functions and steps may be repeated, and the agenda re-arranged or re-calculated, as attendees are added to or removed from the event.

Use Case

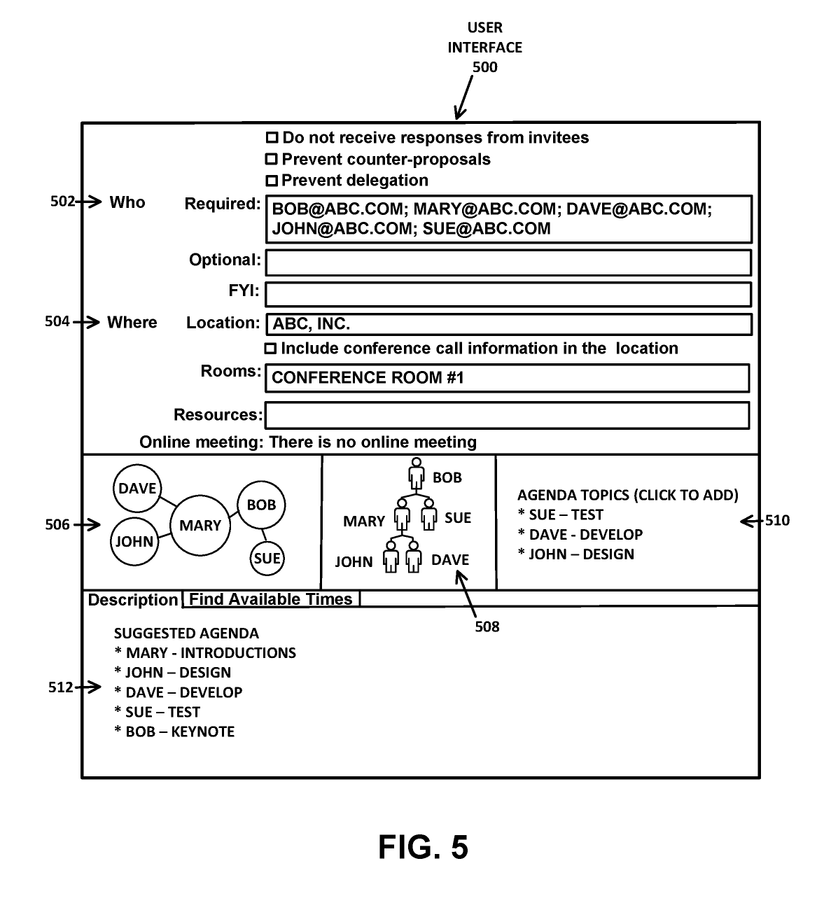

Consider the following use case illustrated in FIG. 5. Specifically, FIG. 5 shows a user interface 500 displayed by the browser 200 and/or agent 202 executed by the user's devices 108, 110, 112, for a function defining a meeting invitation. Typically, the function defining a meeting is part of a Calendar application, although it may be included in other applications as well.

The user interface 500 includes a “Who:” identification 502, such as required attendees (“Required”), optional attendees (“Optional”), and other persons to be notified but not invited (“FYI”). Check boxes are provided to indicate: do not receive responses from invitees, prevent counter-proposals, and prevent delegation.

The user interface 500 also includes a “Where” identification 504, such as the location of the meeting (“Location”), rooms (“Rooms:”), resources (“Resources:”), and online meeting links (“Online Meeting:”), if any. A check box is provided to indicate: include conference call information in the location.

In addition, the user interface 500 may optionally include a social relationship graph 506 for the attendees and/or an organizational chart 508 of the attendees. The graph 506 and chart 508 are populated with the names of the attendees, and may include their photograph or avatars.

Another panel is provided in 510, where the organizer enters agenda topics, as well as the attendees who should present on those topics. Note that the agenda topics can be listed in any order in this panel 510.

Finally, the user interface 500 includes two tabs, wherein a first tab (“Description”) 512 includes a suggested agenda (which may include attachments), and a second tab (“Find Available Times”) (not shown) shows the availability of the invited attendees, from the attendees' personal calendars.

In this use case, the required attendees are listed by their email addresses in the “Who:” identification 502: Bob@abc.com, Mary@abc.com, Dave@abc.com, John@abc.com, and Sue@abc.com. There are no “Optional:” attendees or “FYI:” notifications.

The “Where:” identification 504 has a “Location:” of ABC, Inc. with “Rooms:” specified as Conference Room #1. There are no “Resources:” identified, nor is there an online meeting.

A social relationship graph 506 is displayed based on the attendees' social relationships. In this example, the social relationship graph 506 indicates that John, Dave and Bob know Mary; Sue knows Bob, but has never met Mary; and Bob has never met John or Dave. The weightings indicate that the more commonly known attendee in the social relationship graph 506 is Mary.

An organizational chart 508 is displayed based on the attendees' working relationships. In this example, the organizational chart 508 indicates that Bob has the highest position in the organizational chart 508, Mary and Sue have the next highest positions in the organizational chart 508, and John and Dave have the lowest positions in the organizational chart 508.

The event organizer (which, in this example, is Mary), enters agenda topics into panel 510. In this example, the topics include Test (to be presented by Sue), Develop (to be presented by Dave), and Design (to be presented by John).

Using this information, an agenda is automatically arranged and displayed in panel 512, wherein the agenda includes introductions, a suggested ordering for the topics on the agenda from panel 510, and a keynote speech as a closing statement. The agenda suggests that Mary should make the introductions, followed by presentations on Design by John, Develop by Dave, and Test by Sue, with the keynote speech by Bob.

Although not shown, the agenda can further suggest talking about commonly shared artifacts (people, hobbies and job functionality).

Thus, the present invention provides a computer-implemented system for meeting facilitation that intelligently arranges social and business events, including an agenda of topics to be discussed, based on a social relationship graph of the attendees, an organizational chart of the attendees, job or work functions of the attendees, and respect for the local social or business culture.

Flowchart

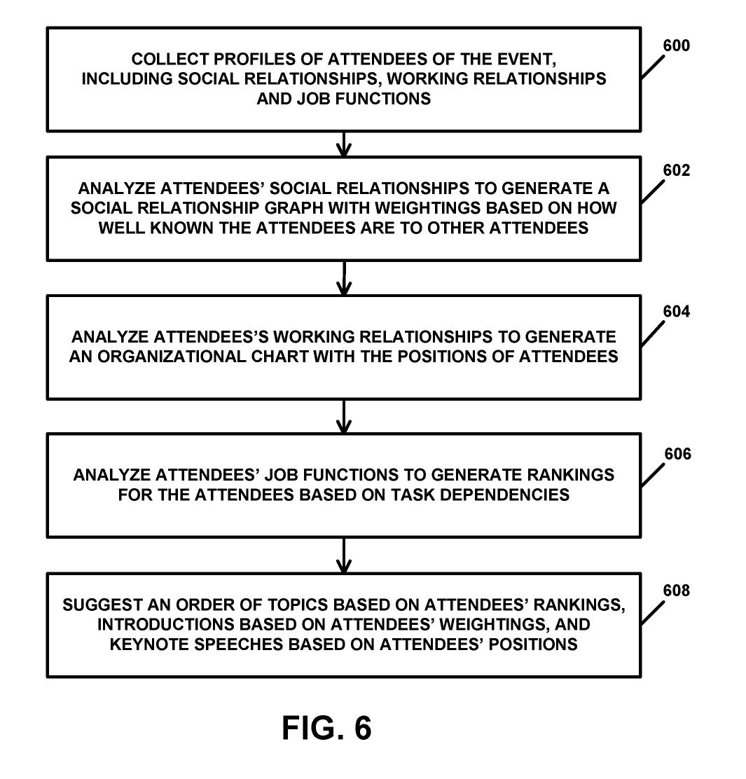

FIG. 6 is a flowchart illustrating the steps performed by the system 100 when implementing the computer-implemented method of this invention, according to one embodiment. Specifically, these steps comprise the system 100 automatically arranging an event's agenda. The automatic arrangement is typically performed when a meeting invitation is being drafted.

Block 600 represents the system 100 collecting profiles for attendees of the event, wherein the profiles include the attendees' social relationships, working relationships and job functions.

Block 602 represents the system 100 analyzing the attendees' social relationships to generate a social relationship graph that includes weightings for the attendees based on how well known they are to others of the attendees. The attendees who are more commonly known have higher weightings in the social relationship graph than the attendees who are less commonly known.

Block 604 represents the system 100 analyzing the attendees' working relationships to generate an organizational chart therefrom that includes the attendees' positions.

Block 606 represents the system 100 analyzing the attendees' job functions, as well as transitions and workflows in the attendee's job functions, to generate rankings for the attendees based on task dependencies. The attendees whose job functions are at a beginning of the task dependencies have higher rankings than the attendees whose job functions are at a later stage or an end of the task dependencies.

Block 608 represents the system 100 suggesting an order for topics on the agenda according to the rankings for the attendees, wherein the suggested order for topics on the agenda has the attendees with higher rankings present before the attendees with lower rankings.

Block 608 also represents the system 100 suggesting introductions for the agenda according to the weightings for the attendees in the social relationship graph. The suggested introductions are made by the attendees with higher weightings in the social relationship graph.

In addition, Block 608 represents the system 100 suggesting keynote speeches for the agenda according to the attendees' positions in the organizational chart. The suggested keynote speeches are made by the attendees positioned higher in the organizational chart.

Finally, Block 608 represents the system 100 considering a social and business culture based on a location of the event, as well as a cultural background of the attendees, when arranging the agenda.

These Blocks 600-608 may be repeated by the system 100 for re-arranging or re-calculating the agenda as attendees are added to or removed from the event.

Summary

In summary, it can be seen that the present invention provides a number of benefits and advantages. These benefits and advantages include improvements to the technology or technical field of organizing meetings, and more specifically, improving attendee and/or event productivity and efficiency. These benefits and advantages also include improvements to the functioning of the computer itself, as compared to prior computer-implemented methods and systems for scheduling and organizing meetings.

With regard to improvements to the technology or technical field, the computer-implemented method and system for meeting facilitation intelligently arranges an agenda for social and business events or meetings, including topics to be discussed, based on: social relationships among an event's attendees, working relationships among the attendees, job functions of the attendees, and respect for the local social or business culture.

With regard to improvements to the functioning of the computer itself, the computer-implemented method and system of this invention performs: a step or function that collects the event attendees' profiles, including the attendees' social relationships, working relationships and job functions; a step or function that analyzes the attendees' social relationships to generate a social relationship graph weighting the attendees according to how well known they are to other attendees; a step or function that analyzes the attendees' working relationships to generate an organizational chart of the attendees according to their position; a step or function that analyzes the attendees' job functions, as well as the transitions and workflows in the attendee's job functions, and provides rankings for the attendees based on task dependencies; a step or function that considers the social and business culture based on a location of the event, as well as the cultural background of the attendees; and a step or function that suggests an agenda for the event, including an order for topics on the agenda, as well as introductions and keynote speeches, based on the attendees' weightings in the social relationship graph, the attendees' positions in the organizational chart, and the attendees' rankings based on task dependencies.

Both generally and specifically, these steps and functions of the computer-implemented method and system comprise specific improvements other than what is well-understood, routine and conventional in the field. Moreover, these steps and functions of the computer-implemented method and system add unconventional steps to a particular useful application.

Computer Program Product

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart illustrations and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart illustrations and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart illustrations and/or block diagram block or blocks.

The flowchart illustrations and block diagrams in the Figures illustrate the architecture, functionality, and operation of possible implementations of systems, methods, and computer program products according to various embodiments of the present invention. In this regard, each block in the flowchart illustrations or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

### CONCLUSION

This concludes the description of the various embodiments of the present invention. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Since many embodiments of the invention can be made without departing from the spirit and scope of the invention, the invention resides in the claims hereinafter appended.

What is claimed is:

1. A computer-implemented method, comprising:
automatically arranging an event's agenda by:
collecting profiles for attendees of the event, wherein the profiles include the attendees' job functions;
analyzing the attendees' job functions, as well as transitions and workflows in the attendee's job functions, to generate rankings for the attendees based on task dependencies; and
suggesting an order for topics on the agenda according to the rankings for the attendees.

2. The method of claim 1, wherein the attendees whose job functions are at a beginning of the task dependencies have higher rankings than the attendees whose job functions are at a later stage or an end of the task dependencies.

3. The method of claim 2, wherein the suggested order for topics on the agenda has the attendees with the higher rankings present before the attendees with lower rankings.

4. The method of claim 1, wherein the profiles include the attendees' social relationships and the method further comprises:
analyzing the attendees' social relationships to generate a social relationship graph that includes weightings for the attendees based on how well known they are to others of the attendees; and
suggesting introductions for the agenda according to the weightings for the attendees in the social relationship graph.

5. The method of claim 4, wherein the attendees who are more commonly known have greater weightings in the social relationship graph than the attendees who are less commonly known.

6. The method of claim 5, wherein the suggested introductions are made by the attendees with the greater weightings in the social relationship graph.

7. The method of claim 1, wherein the profiles include the attendees' working relationships and the method further comprises:
analyzing the attendees' working relationships to generate an organizational chart that includes the attendees' positions; and
suggesting keynote speeches for the agenda according to the attendees' positions in the organizational chart.

8. The method of claim 8, wherein the suggested keynote speeches are made by the attendees positioned higher in the organizational chart.

9. The method of claim 1, wherein the automatically arranging step is performed when a meeting invitation is being drafted.

10. The method of claim 1, further comprising applying predefined rules to the agenda, wherein the rules concur with or override the agenda.

11. The method of claim 1, further comprising considering a social and business culture based on a location of the event, as well as a cultural background of the attendees, when arranging the agenda.

12. The method of claim 1, further comprising re-arranging or re-calculating the agenda as attendees are added to or removed from the event.

13. A computer-implemented system, comprising:
one or more computers programmed for automatically arranging an event's agenda by:
collecting profiles for attendees of the event, wherein the profiles include the attendees' job functions;
analyzing the attendees' job functions, as well as transitions and workflows in the attendee's job functions, to generate rankings for the attendees based on task dependencies; and
suggesting an order for topics on the agenda according to the rankings for the attendees based on the task dependencies.

14. The system of claim 13, wherein the attendees whose job functions are at a beginning of the task dependencies have higher rankings than the attendees whose job functions are at a later stage or an end of the task dependencies, and the suggested order for topics on the agenda has the attendees with the higher rankings present before the attendees with lower rankings.

15. The system of claim 13, wherein the profiles include the attendees' social relationships and the method further comprises:
analyzing the attendees' social relationships to generate a social relationship graph that includes weightings for the attendees based on how well known they are to others of the attendees, wherein the attendees who are more commonly known have greater weightings in the social relationship graph than the attendees who are less commonly known; and
suggesting introductions for the agenda according to the weightings for the attendees in the social relationship graph, wherein the suggested introductions are made by the attendees with the greater weightings in the social relationship graph.

16. The system of claim 13, wherein the profiles include the attendees' working relationships and the method further comprises:
analyzing the attendees' working relationships to generate an organizational chart that includes the attendees' positions; and
suggesting keynote speeches for the agenda according to the attendees' positions in the organizational chart, wherein the suggested keynote speeches are made by the attendees positioned higher in the organizational chart.

17. A computer program product, the computer program product comprising a computer readable storage medium having program instructions embodied therewith, the program instructions executable by one or more computers to cause the computers to perform a method comprising:
automatically arranging an event's agenda by:
collecting profiles for attendees of the event, wherein the profiles include the attendees' job functions;
analyzing the attendees' job functions, as well as transitions and workflows in the attendee's job functions, to generate rankings for the attendees based on task dependencies; and
suggesting an order for topics on the agenda according to the rankings for the attendees based on the task dependencies.

18. The computer program product of claim 17, wherein the attendees whose job functions are at a beginning of the task dependencies have higher rankings than the attendees whose job functions are at a later stage or an end of the task dependencies, and the suggested order for topics on the agenda has the attendees with the higher rankings present before the attendees with lower rankings.

19. The computer program product of claim 17, wherein the profiles include the attendees' social relationships and the method further comprises:
analyzing the attendees' social relationships to generate a social relationship graph that includes weightings for the attendees based on how well known they are to others of the attendees, wherein the attendees who are more commonly known have greater weightings in the social relationship graph than the attendees who are less commonly known; and
suggesting introductions for the agenda according to the weightings for the attendees in the social relationship graph, wherein the suggested introductions are made by the attendees with the greater weightings in the social relationship graph.

20. The computer program product of claim 17, wherein the profiles include the attendees' working relationships and the method further comprises:
analyzing the attendees' working relationships to generate an organizational chart that includes the attendees' positions; and
suggesting keynote speeches for the agenda according to the attendees' positions in the organizational chart, wherein the suggested keynote speeches are made by the attendees positioned higher in the organizational chart.
